(19) United States
(12) Patent Application Publication
(10) Pub. No.: US 2010/0008006 A1
(43) Pub. Date: Jan. 14, 2010

(54) POWER DEVICE AND SAFETY CONTROL METHOD THEREOF

(75) Inventors: Matsumoto Satoru, Seongnam-si (KR); Eun Ah Kang, Incheon (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/480,361

(22) Filed: Jun. 8, 2009

(30) Foreign Application Priority Data
Jul. 14, 2008 (KR) 10-2008-88192

(51) Int. Cl. H02H 3/08

(52) U.S. Cl. 361/93.1

(57) ABSTRACT

Disclosed herein are a power device and a safety control method thereof which can detect an abnormal state of a power line. The power device includes a detector to detect current of alternating current (AC) power applied to an electronic appliance, and a controller to compare a value of the detected current with an abnormal current reference value set according to an operation mode of the electronic appliance and interrupt the AC power if the detected current value is larger than the abnormal current reference value. The controller changes the abnormal current reference value according to the operation mode.

### CROSS-REFERENCE TO RELATED APPLICATIONS

This application claims the benefit of Korean Patent Application No. 2008-0068192, filed on Jul. 14, 2008 in the Korean Intellectual Property Office, the disclosure of which is incorporated herein by reference.

### BACKGROUND

1. Field

The present invention relates to a power device and a safety control method thereof, and, more particularly, to a power device and a safety control method thereof which can detect an abnormal state of a power line to protect an electronic appliance.

2. Description of the Related Art

Generally, in an electronic appliance (for example, a laundry machine or dish washer) having a load that is driven by a power supply to which alternating current (AC) power is applied, a power safety device is installed in a power line to protect the electronic appliance. This power safety device functions to determine whether the voltage or current of the AC power applied to the electronic appliance is an overvoltage or overcurrent and automatically interrupt the power to a main control circuit of the electronic appliance upon detecting an abnormal state resulting from the overvoltage or overcurrent.

An example of such a power safety device is a protection device for an electronic appliance disclosed in Korean Patent Laid-open Publication No. 1997-55031.

The power safety device disclosed in this publication is configured to determine whether the voltage of AC power applied from a power plug is an overvoltage and, upon determining the voltage of the AC power to be the overvoltage, automatically interrupt the power to the electronic appliance before the overvoltage is applied to a driving circuit of the electronic appliance.

However, conventional power safety devices including the power safety device disclosed in Korean Patent Laid-open Publication No. 1997-55031 are disadvantageous in that they interrupt the AC power to the electronic appliance only when detecting an overvoltage (or overcurrent) of the AC power excessively deviating from a rated range (rated voltage or current range). In other words, the conventional power safety devices cannot detect an abnormal state of the power line which occurs within the rated range due to a semi-short circuit, crack, mechanical stress, etc. of internal electronic components of the electronic appliance, and, accordingly, cannot securely prevent a PL accident.

### SUMMARY

Therefore, it is an aspect of the present invention to provide a power device and a safety control method thereof which can accurately detect an abnormal state of a power line occurring within a rated range to more securely protect an electronic appliance.

It is another aspect of the present invention to provide a power device and a safety control method thereof which can change an abnormality determination criterion for a power line according to an operation mode to accurately detect an abnormal state of the power line within a rated range.

It is a further aspect of the present invention to provide a power device and a safety control method thereof which can accurately determine an operation mode through detection of current of a power line or communication with a main control circuit to change an abnormality determination criterion for the power line.

Additional aspects and/or advantages of the invention will be set forth in part in the description which follows and, in part, will be apparent from the description, or may be learned by practice of the invention.

The foregoing and/or other aspects of the present invention are achieved by providing a power device operating in connection with an electronic appliance, the power device including: a detector to detect current of alternating current (AC) power applied to the electronic appliance; and a controller to compare a value of the detected current with an abnormal current reference value set according to an operation mode of the electronic appliance and to interrupt the AC power if the detected current value is larger than the abnormal current reference value.

The controller may determine the operation mode of the electronic appliance based on the detected current value and change the abnormal current reference value according to the operation mode.

Alternatively, the controller may determine the operation mode of the electronic appliance through communication with the electronic appliance and change the abnormal current reference value according to the operation mode.

The power device may further include an interrupter to turn on/off a power line of the AC power under control of the controller.

The abnormal current reference value may be an abnormal current value capable of generating an arc in the operation mode of the electronic appliance.

The power device may be installed between a power plug to which the AC power is applied and the electronic appliance, the electronic appliance being connected to a power line of the AC power.

The power device may further include a filter to remove a noise component from the AC power which is applied to the power line through the power plug.

The electronic appliance may be any one of a laundry machine, dish washer, drying machine, refrigerator and air conditioner, and the operation mode may include a standby mode, a motor driving mode and a heater driving mode when the electronic appliance is the laundry machine.

The foregoing and/or other aspects of the present invention are achieved by providing a power device in communication with a power line and an electronic appliance, the power device including: a detector to detect current of alternating current (AC) power of the power line; and a controller to determine an operation mode of the electronic appliance, the AC power applied to the electronic appliance, based on a value of the detected current, set an abnormal current reference value of the power line according to the operation mode, compare the detected current value with the set abnormal current reference value and interrupt the AC power if the detected current value is larger than the abnormal current reference value.

The foregoing and/or other aspects of the present invention are achieved by providing a power device in communication with an electronic appliance, the power device including: a detector to detect current of alternating current (AC) power applied to the electronic appliance; and a controller to determine an operation mode of the electronic appliance through communication with the electronic appliance, set an abnormal current reference value of the AC power according to the operation mode, compare a value of the detected current with the set abnormal current reference value and interrupt the AC power if the detected current value is larger than the abnormal current reference value.

The foregoing and/or other aspects of the present invention are achieved by providing a safety control method of a power device in communication with an electronic appliance and a power line, the power device including: detecting current of alternating current (AC) power of the power line; determining an operation mode of the electronic appliance to which the AC power is applied, based on a value of the detected current; setting an abnormal current reference value of the power line according to the operation mode; and comparing the detected current value with the set abnormal current reference value and interrupting the AC power if the detected current value is larger than the abnormal current reference value.

The foregoing and/or other aspects of the present invention are achieved by providing a safety control method of a power device in communication with an electronic appliance, the power device including: detecting current of alternating current (AC) power applied to the electronic appliance; determining an operation mode of the electronic appliance through communication with the electronic appliance; setting an abnormal current reference value of the AC power according to the operation mode; and comparing a value of the detected current with the set abnormal current reference value and interrupting the AC power if the detected current value is larger than the abnormal current reference value.

The abnormal current reference value may be changed according to the operation mode of the electronic appliance.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram showing the configuration of a power device according to an embodiment of the present invention;

FIG. 2 is a control block diagram of a power supply according to a first embodiment of the present invention;

FIG. 3 is a control block diagram of a power supply according to a second embodiment of the present invention;

FIG. 4 is a flowchart illustrating a safety control method of a power device according to the first embodiment of the present invention; and

FIG. 5 is a flowchart illustrating a safety control method of a power device according to the second embodiment of the present invention.

### DETAILED DESCRIPTION OF EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

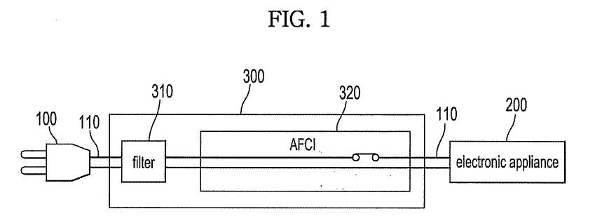

FIG. 1 is a block diagram showing the configuration of a power device according to an embodiment of the present invention.

In FIG. 1, the power device of the present invention, denoted by reference numeral 300, is a power safety device that is installed between a power plug 100 to which AC power is applied and an electronic appliance (for example, a laundry machine, dish washer, drying machine, refrigerator or air conditioner) 200 connected to a power line 110 of the AC power applied from the power plug 100.

The power device 300 of the embodiments of the present invention is adapted to detect, not only overcurrent excessively deviating from a rated range (rated current range), but also abnormal current which occurs within the rated range due to a semi-short circuit, crack, mechanical stress, etc. of internal electronic components of the electronic appliance 200, so as to interrupt the AC power to the electronic appliance 200 upon occurrence of an abnormality in the power line 110. To this end, the power device 300 includes a filter 310 to remove a noise component from the AC power that is applied to the power line 110 through the power plug 100, and a power supply 320 to turn on/off the AC power to the electronic appliance 200 according to whether the current of the AC power from which the noise component has been removed by the filter 310 corresponds to an abnormal state or overload state.

In the power device 300 of the embodiments of the present invention, the power supply 320 is installed downstream of the filter 310 so that it can stably operate with no error resulting from the noise component. On the other hand, the filter 310 and the power supply 320 may be integrated into one assembly and built in the electronic appliance 200.

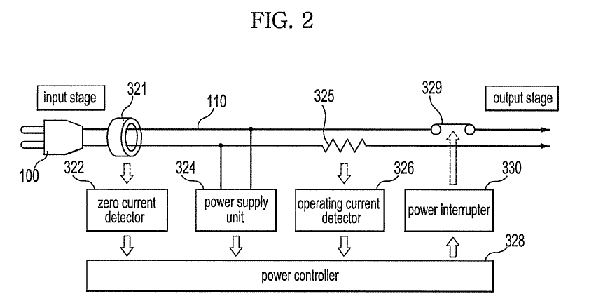

FIG. 2 is a control block diagram of the power supply 320 according to a first embodiment of the present invention.

In FIG. 2, the power supply 320 of the present invention is an arc fault circuit interrupter (AFCI) including a zero current detector 322, a power supply unit 324, an operating current detector 326, a power controller 328, and a power interrupter 330.

The AFCI is an electric safety device that is prescribed to be installed in the electronic appliance 200 by the US NEC standard in consideration of the fact that about 90% of electric fires occur due to electric arcs. This AFCI was mainly applied to airplanes initially and the application thereof has been gradually spread out to the electronic appliance 200 for home use. At present, the AFCI is mandatory in the USA and has also begun to be applied in Canada and the European Union. In this regard, it is expected that the AFCI will be applied in many countries by about 2010.

The zero current detector 322 detects leakage current of the AC power flowing through the power line 110 and outputs the value of the detected leakage current to the power controller 328. To this end, the zero current detector 322 includes a zero current transformer 321 and peripheral circuits.

The power supply unit 324 outputs driving power for the operation of the power supply 320 to the power controller 328. The operating current detector 326 detects operating current of the AC power which is applied from the power plug 100 to the electronic appliance 200 through the power line 110 and outputs the value of the detected operating current to the power controller 328. To this end, the operating current detector 326 includes a shunt resistor 325 and peripheral circuits.

The power controller 328 is an AFCI control integrated circuit (IC) that operates with the driving power from the power supply unit 324 to control the operation of the power interrupter 330 based on the detected current values from the zero current detector 322 and operating current detector 326. This power controller 328 determines whether the current of the AC power is leakage current or abnormal current, based on the current values inputted from the zero current detector 322 and operating current detector 326, and, upon detecting an abnormal state of the power line 110 resulting from the leakage current or abnormal current, controls the power interrupter 330 to interrupt the power to the electronic appliance 200 to protect the electronic appliance 200.

Also, the power controller 328 determines the operation mode of the electronic appliance 200 based on the operating current value from the operating current detector 326 and changes an abnormal current reference value for determination of the abnormal state of the power line 110 according to the operation mode to determine whether the present operating current is current resulting from the abnormal state of the power line 110 or current resulting from an overload state. That is, the power controller 328 can accurately determine whether the operating current of the power line 110 corresponds to the abnormal state or overload state, by changing the abnormal current reference value suitably to the operation mode using the fact that the operating current of the power line 110 significantly varies with the operation mode (for example, a standby mode, motor driving mode or heater driving mode in a laundry machine) of the electronic appliance 200 within the rated range.

The power interrupter 330 interrupts the AC power which is applied to the electronic appliance 200 through the power line 110, under the control of the power controller 328, to secure operation stability of the electronic appliance 200. To this end, the power interrupter 330 includes a circuit breaker 329 and peripheral circuits.

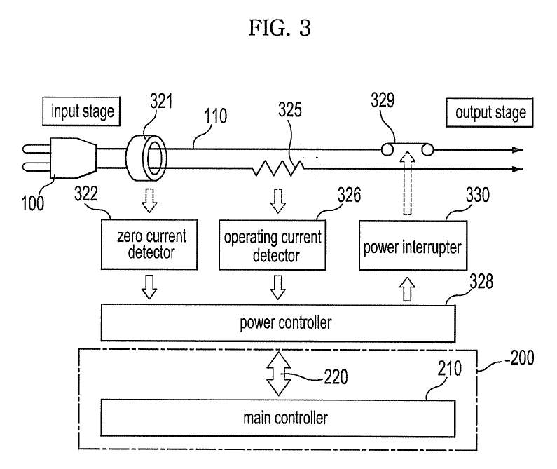

FIG. 3 is a control block diagram of the power supply 320 according to a second embodiment of the present invention. Some parts in the second embodiment are the same as those in the first embodiment shown in FIG. 2. Therefore, the same parts are denoted by the same reference numerals and names and a duplicate description thereof will be omitted.

In FIG. 3, the power controller 328 of the second embodiments of the present invention is electrically connected with a main controller 210 of the electronic appliance 200 via a communication interface (for example, a universal asynchronous receiver/transmitter (UART) communication interface) 220 to receive information about the operation mode of the electronic appliance 200 from the main controller 210. This makes it possible to further subdivide and change the abnormal current reference value for determination of the abnormal state of the power line 110 rather than in the case (see FIG. 2) of determining the operation mode of the electronic appliance 200 based on the operating current of the power line 110. As a result, the power controller 328 can more accurately determine whether the present operating current is current resulting from the abnormal state of the power line 110 or current resulting from the overload state.

Also, the power controller 328 can be supplied with the driving power for the operation of the power supply 320 through the main controller 210, and thus there is no need to install the power supply unit 324 separately. As a result, it is possible to remove the power supply unit 324.

Hereinafter, a description will be given of a safety control method of the power device with the above-stated configuration.

The present invention relates to a power safety device that detects an abnormal state of the AC power applied to the electronic appliance 200 through the power line 110 to securely protect the electronic appliance 200, in which a laundry machine will be taken as an example of the electronic appliance 200 applied to the embodiments of the present invention. The laundry machine is usually installed outdoors, in a bathroom or the like, so that it is often used under unfavorable conditions such as high temperature, low temperature and high humidity. Also, the laundry machine often vibrates due to characteristics thereof. For this reason, internal electronic components of the laundry machine may be subject to a semi-short circuit or crack due to environments (moisture penetration, detergent attachment, dust deposition, etc.) applied thereto or mechanical stress thereof, resulting in a PL accident such as smoke or fire. In this connection, a description will hereinafter be given of a method to securely interrupt AC power to the laundry machine upon arc generation by detecting abnormal current within a rated range that is generated in the standby mode, motor driving mode or heater driving mode of the laundry machine.

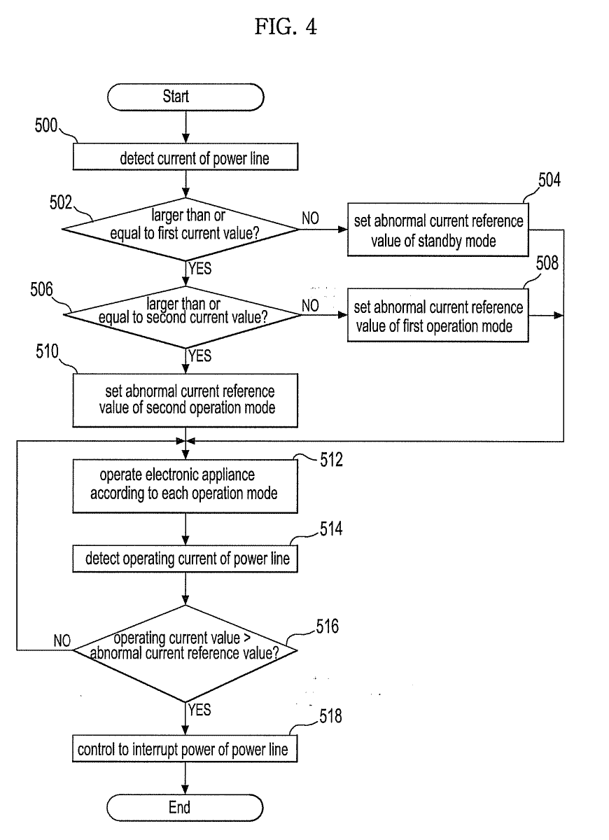

FIG. 4 is a flowchart illustrating the safety control method of the power device according to the first embodiment of the present invention.

In FIG. 4, the operating current detector 326 of the power device 300 detects the current of the AC power which is applied to the power line 110 through the power plug 100 and outputs the value of the detected current to the power controller 328 (500).

The power controller 328 receives the value of the current of the power line 110 detected by the operating current detector 326 and determines whether the received current value is larger than or equal to a predetermined first current value (for example, 0.1 A) (502). When the current value of the power line 110 is not larger than or equal to the first current value, the power controller 328 determines the present operation mode of the electronic appliance 200 to be the standby mode and thus sets an abnormal current reference value of the standby mode (an abnormal current value capable of generating an arc in the standby mode: about 1 A or more) as the reference value for detection of the abnormal state of the power line 110 (504). Here, the first current value is a reference value for determination as to whether the operation mode of the electronic appliance 200 is the standby mode, and is set to 0.1 A in consideration of the fact that the current value of the standby mode is on the order of 0.1 A under a normal current condition in the laundry machine.

When it is determined at operation 502 that the current value of the power line 110 is larger than or equal to the first current value, the power controller 328 determines whether the current value of the power line 110 is larger than or equal to a predetermined second current value (for example, 10 A) (506). When the current value of the power line 110 is not larger than or equal to the second current value, the power controller 328 determines the present operation mode of the electronic appliance 200 to be a first operation mode (more particularly, the motor driving mode) and thus sets an abnormal current reference value of the first operation mode (an abnormal current value capable of generating an arc in the motor driving mode: about 7 to 8 A or more) as the reference value for detection of the abnormal state of the power line 110 (508). Here, the second current value is a reference value for determination as to whether the operation mode of the electronic appliance 200 is the motor driving mode, and is set to 10 A in consideration of the fact that the current value of the motor driving mode is less than 10 A under the normal current condition in the laundry machine.

When it is determined at operation 506 that the current value of the power line 110 is larger than or equal to the second current value, the power controller 328 determines the present operation mode of the electronic appliance 200 to be a second operation mode (more particularly, the heater driving mode) and thus sets an abnormal current reference value of the second operation mode (an abnormal current value capable of generating an arc in the heater driving mode: about 15 A or more) as the reference value for detection of the abnormal state of the power line 110 (510).

In this manner, the power controller 328 changes the abnormal current reference value for detection of the abnormal state of the power line 110 according to the operation mode of the electronic appliance 200. Therefore, the power controller 328 can prevent even a faulty operation to misrecognize an overload state resulting from various factors in each operation mode to be the abnormal state of the power line 110 and thus interrupt the AC power.

If the abnormal current reference value is set according to each operation mode of the electronic appliance 200 as stated above and the electronic appliance 200 operates according to each operation mode (512), the operating current detector 326 installed in the power line 110 detects operating current of the power line 110 and outputs the value of the detected operating current to the power controller 328 (514).

The power controller 328 receives the value of the operating current of the power line 110 detected by the operating current detector 326 and determines whether the received operating current value is larger than the abnormal current reference value set suitably to each operation mode (516). When the operating current value of the power line 110 is not larger than the set abnormal current reference value, the power controller 328 returns to operation 512 to perform this operation and the subsequent operations.

In the case where it is determined at operation 516 that the operating current value of the power line 110 is larger than the set abnormal current reference value, the power controller 328 determines the present state to be the abnormal state of the power line 110 and thus outputs a control signal to the power interrupter 330 to interrupt the AC power applied to the electronic appliance 200 through the power line 110.

In response to the control signal from the power controller 328, the power interrupter 330 operates the circuit breaker 329 that turns on/off the AC power of the power line 110. As a result, the circuit breaker 329 interrupts the AC power applied from the power plug 100 to the electronic appliance 200 through the power line 110, so as to securely protect the electronic appliance 200 (518).

In FIG. 4, the operation mode of the electronic appliance 200 has been described to be determined through detection of the current of the power line 110. In this case, however, there may be a limitation in further subdividing the operation mode of the electronic appliance 200. That is, because the current of the power line 110 may not be accurately detected due to a small current variation, noise, etc. of the power line 110, the operation mode of the laundry machine is limited to the standby mode, motor driving mode and heater driving mode where the current of the power line 110 varies significantly, and the abnormal current reference value is changed suitably to a given operation mode.

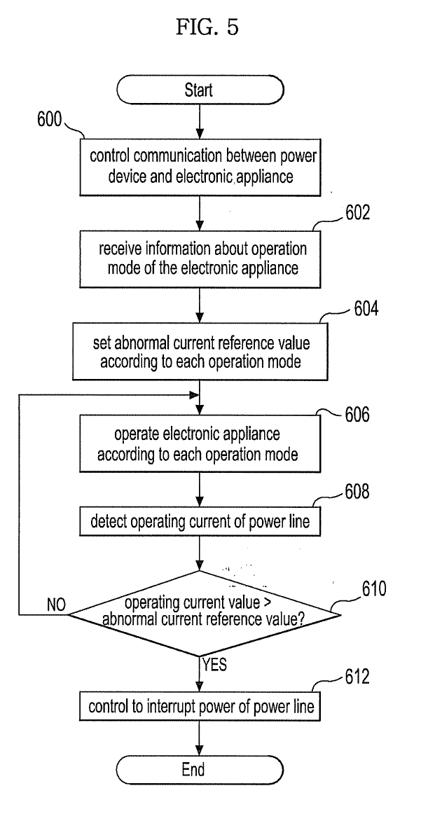

In contrast, in FIG. 5, information about the operation mode of the electronic appliance 200 is received through communication with the electronic appliance 200, in order to make up for the power control method of FIG. 4 in which there is no choice but to limit the operation mode.

FIG. 5 is a flowchart illustrating the safety control method of the power device according to the second embodiment of the present invention.

In FIG. 5, when the power device 300 and the electronic appliance 200 are electrically connected to each other in a communicable manner, the power controller 328 of the power device 300 and the main controller 210 of the electronic appliance 200 communicate with each other via the communication interface (for example, a UART communication interface) 220 (600).

As a result, the power controller 328 receives information about each operation mode of the electronic appliance 200 from the main controller 210 of the electronic appliance 200 (602) and sets an abnormal current reference value predetermined suitably to each operation mode as the reference value for detection of the abnormal state of the power line 110 according to each operation mode (604).

If the abnormal current reference value is set according to each operation mode of the electronic appliance 200 as stated above and the electronic appliance 200 operates according to each operation mode (606), the operating current detector 326 installed in the power line 110 detects operating current of the power line 110 and outputs the value of the detected operating current to the power controller 328 (608).

The power controller 328 receives the value of the operating current of the power line 110 detected by the operating current detector 326 and determines whether the received operating current value is larger than the abnormal current reference value set to each operation mode (610). When the operating current value of the power line 110 is not larger than the set abnormal current reference value, the power controller 328 returns to operation 606 to perform this operation and the subsequent operations.

In the case where it is determined at operation 610 that the operating current value of the power line 110 is larger than the set abnormal current reference value, the power controller 328 determines the present state to be the abnormal state of the power line 110 and thus outputs a control signal to the power interrupter 330 to interrupt the AC power applied to the electronic appliance 200 through the power line 110.

In response to the control signal from the power controller 328, the power interrupter 330 operates the circuit breaker 329 that turns on/off the AC power of the power line 110. As a result, the circuit breaker 329 interrupts the AC power applied from the power plug 100 to the electronic appliance 200 through the power line 110, so as to securely protect the electronic appliance 200 (612).

As is apparent from the above description, a power device and a safety control method thereof according to the embodiments of the present invention can accurately detect an abnormal state of a power line occurring within a rated range to more securely protect circuits of an electronic appliance having a load that is driven by a power supply to which AC power is applied.

Further, it is possible to accurately determine an operation mode of an electronic appliance through detection of current of a power line or communication with a main control circuit to accurately change an abnormality determination criterion for the power line suitably to the operation mode, thereby preventing a faulty operation to misrecognize an overload state to be an abnormal state and thus interrupt the AC power and accurately detecting only an abnormal state within a rated range.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A power device operating in connection with an electronic appliance, the power device comprising:
a detector to detect current of alternating current (AC) power applied to the electronic appliance; and
a controller to compare a value of the detected current with an abnormal current reference value set according to an operation mode of the electronic appliance and to interrupt the AC power if the detected current value is larger than the abnormal current reference value.

2. The power device according to claim 1, wherein the controller determines the operation mode of the electronic appliance based on the detected current value and changes the abnormal current reference value according to the operation mode.

3. The power device according to claim 1, wherein the controller determines the operation mode of the electronic appliance through communication with the electronic appliance and changes the abnormal current reference value according to the operation mode.

4. The power device according to claim 1, further comprising an interrupter to turn on/off a power line applying the AC power under control of the controller.

5. The power device according to claim 1, wherein the abnormal current reference value is an abnormal current value capable of generating an arc in the operation mode of the electronic appliance.

6. The power device according to claim 1; wherein the power device is installed between a power plug to which the AC power is applied and the electronic appliance, the electronic appliance being connected to the power device with a power line.

7. The power device according to claim 6, further comprising a filter to remove a noise component from the AC power which is applied to the power line through the power plug.

8. The power device according to claim 1, wherein the electronic appliance is a laundry machine, dish washer, drying machine, refrigerator and/or conditioner.

9. The power device according to claim 8, wherein the operation mode includes a standby mode, a motor driving mode and a heater driving mode when the electronic appliance is the laundry machine.

10. A power device in communication with a power line and an electronic appliance, the power device comprising:
a detector to detect current of alternating current (AC) power of the power line; and
a controller to determine an operation mode of the electronic appliance, based on a value of the detected current, set an abnormal current reference value of the power line according to the operation mode, compare the detected current value with the set abnormal current reference value and interrupt the AC power if the detected current value is larger than the abnormal current reference value, the AC power being applied to the electronic appliance.

11. A power device in communication with an electronic appliance, the power device comprising:
a detector to detect current of alternating current (AC) power applied to the electronic appliance; and
a controller to determine an operation mode of the electronic appliance through communication with the electronic appliance, set an abnormal current reference value of the AC power according to the operation mode, compare a value of the detected current with the set abnormal current reference value and interrupt the AC power if the detected current value is larger than the abnormal current reference value.

12. The power device according to claim 10, wherein the controller changes the abnormal current reference value according to the operation mode.

13. The power device according to claim 10, wherein the abnormal current reference value is an abnormal current value capable of generating an arc in the operation mode of the electronic appliance.

14. A safety control method of a power device in communication with an electronic appliance and a power line, the method comprising:
detecting current of alternating current (AC) power of the power line;
determining an operation mode of the electronic appliance to which the AC power is applied, based on a value of the detected current;
setting an abnormal current reference value of the power line according to the operation mode; and
comparing the detected current value with the set abnormal current reference value and interrupting the AC power if the detected current value is larger than the abnormal current reference value.

15. A safety control method of a power device in communication with an electronic appliance, the power device comprising:
detecting current of alternating current (AC) power applied to the electronic appliance;
determining an operation mode of the electronic appliance through communication with the electronic appliance;
setting an abnormal current reference value of the AC power according to the operation mode; and
comparing a value of the detected current with the set abnormal current reference value and interrupting the AC power if the detected current-value is larger than the abnormal current reference value.

16. The safety control method according to claim 14, wherein the abnormal current reference value is an abnormal current value capable of generating an arc in the operation mode of the electronic appliance.

17. The safety control method according to claim 14, wherein the abnormal current reference value is changed according to the operation mode of the electronic appliance.

18. The power device according to claim 11, wherein the controller changes the abnormal current reference value according to the operation mode.

19. The power device according to claim 11, wherein the abnormal current reference value is an abnormal current value capable of generating an arc in the operation mode of the electronic appliance.

20. The safety control method according to claim 15, wherein the abnormal current reference value is an abnormal current value capable of generating an arc in the operation mode of the electronic appliance.

21. The safety control method according to claim 15, wherein the abnormal current reference value is changed according to the operation mode of the electronic appliance.
